(19) United States
(12) Patent Application Publication
(10) Pub. No.: US 2012/0006351 A1
(43) Pub. Date: Jan. 12, 2012

(54) Methods Of Cleaning And Plasma Processing Apparatus For Manufacturing Semiconductors

(75) Inventors: Hyun-Su Jun, Hwaseong-si (KR); Hun-Jung Yi, Suwon-si (KR); Sang-jean Jeon, Hwaseong-si (KR); Se-Yeon Kim, Hwaseong-si (KR); In-Joong Kim, Seoul (KR)

(73) Assignee: SAMSUNG ELECTRONICS CO., LTD., Suwon-si (KR)

(21) Appl. No.: 13/176,868

(22) Filed: Jul. 6, 2011

(30) Foreign Application Priority Data
Jul. 6, 2010 (KR) 10-2010-0064916

(51) Int. Cl. B08B 7/00

(52) U.S. Cl. 134/1.1

(57) ABSTRACT

A cleaning method for cleaning a semiconductor manufacturing apparatus may include generating plasma from a cleaning gas. The semiconductor manufacturing apparatus may be cleaned with the plasma. A positive direct-current voltage may be applied to an ESC of the semiconductor manufacturing apparatus during a cleaning of the semiconductor manufacturing apparatus. A negative direct-current voltage may be applied to the ESC during the cleaning of the semiconductor manufacturing apparatus. Also, a wall of the process chamber may be cleaned by applying the positive direct-current voltage to the ESC.

### CROSS-REFERENCE TO RELATED APPLICATION

This application claims priority under 35 U.S.C. §119 to Korean Patent Application No. 10-2010-64916 filed on Jul. 6, 2010, in the Korean Intellectual Property Office (KIPO), the disclosure of which is hereby incorporated by reference in its entirety.

### BACKGROUND

1. Field

Example embodiments of the inventive concepts relate to a plasma processing apparatus and/or methods of cleaning the plasma processing apparatus.

2. Description of Related Art

Plasma processing apparatuses may be used in the fabrication of semiconductor components. Some conventional plasma processing apparatuses utilize an in-situ dry cleaning (ISD) process to clean a semiconductor device. The ISD process utilizes plasma in the cleaning process. In the conventional art, the plasma used for cleaning the semiconductor device also contacts various components of the plasma processing apparatus causing damage to the various components thereof.

### SUMMARY

Some example embodiments of the inventive concepts provide methods of cleaning and plasma processing that may reduce or prevent damage to an electrostatic chuck (ESC) of a plasma processing apparatus by selectively adjusting a quantity of plasma that reaches a surface of the ESC.

The technical objectives of the inventive concepts are not limited to the above disclosure; other objectives may become apparent to those of ordinary skill in the art based on the following descriptions.

In accordance with an example embodiment, a method of cleaning a semiconductor manufacturing apparatus having a process chamber and an electrostatic chuck (ESC) may include supplying a cleaning gas into the process chamber, generating plasma from the cleaning gas, applying a direct-current voltage to the ESC during a cleaning of at least one of the process chamber and the ESC.

In accordance with another example embodiment of the inventive concepts a method of plasma processing an apparatus for manufacturing a semiconductor may include applying a positive direct-current voltage to an electrostatic chuck (ESC) and applying a negative direct-current voltage to the ESC while cleaning the semiconductor manufacturing apparatus with plasma. In this example embodiment, a wall of the process chamber may be cleaned by applying the positive direct-current voltage to the ESC.

In accordance with another example embodiment of the inventive concepts, a method of cleaning an apparatus for manufacturing a semiconductor may include applying a direct current voltage to a first element of the apparatus for manufacturing the semiconductor to adjust a sheath on the element to one of protect the element from plasma and clean the element using the plasma.

In accordance with an aspect of the inventive concepts, a method of cleaning an apparatus for manufacturing semiconductors includes supplying a cleaning gas into a process chamber including an ESC. Plasma is generated from the cleaning gas. A semiconductor manufacturing apparatus is cleaned with the plasma. In example embodiments, a positive direct-current voltage may be applied to the ESC during the cleaning of the semiconductor manufacturing apparatus. In example embodiments, a negative direct-current voltage may be applied to the ESC during the cleaning of the semiconductor manufacturing apparatus. Also, a wall of the process chamber may be cleaned by applying the positive direct-current voltage to the ESC.

In accordance with another aspect of the inventive concepts, a method of plasma processing an apparatus for manufacturing a semiconductor may include applying a positive direct-current voltage to an ESC and/or applying a negative direct-current voltage to the ESC while plasma is used to clean a semiconductor manufacturing apparatus. A wall of the process chamber may be cleaned by applying the positive direct-current voltage to the ESC.

### BRIEF DESCRIPTION OF THE DRAWINGS

The foregoing and other features and advantages of the inventive concepts will be apparent from the more particular description of the example embodiments illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a cross-sectional view of a semiconductor manufacturing apparatus in accordance with a first example embodiment of the inventive concepts;

FIG. 2A is a graph illustrating changes in potential (Vp) of plasma depending on the application of voltage to an electrostatic chuck (ESC);

FIG. 2B is a graph illustrating the difference between the potential (Vp) of plasma and the potential (Vf) of a process chamber wall depending on the application of voltage to an ESC;

FIG. 3 is a diagram showing the state of plasma when a positive direct-current voltage is applied to an ESC;

FIG. 4 is a diagram showing the state of plasma when a negative direct-current voltage is applied to an ESC;

FIG. 5 is a cross-sectional view of a semiconductor manufacturing apparatus in accordance with a second example embodiment of the inventive concepts;

FIG. 6 is a cross-sectional view of a semiconductor manufacturing apparatus in accordance with a third example embodiment of the inventive concepts.

### DETAILED DESCRIPTION OF THE EXAMPLE EMBODIMENTS

Various embodiments will now be described more fully with reference to the accompanying drawings in which some embodiments are shown. The inventive concepts may, however, be embodied in different forms and should not be construed as limited to the example embodiments set forth herein. Rather, the example embodiments are provided so that this disclosure is thorough and complete and fully conveys the inventive concepts to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers that may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the inventive concepts.

Unless otherwise defined, all terms (including technical and scientific terms) used herein have the same meaning as commonly understood by one of ordinary skill in the art to which the inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### First Example Embodiment

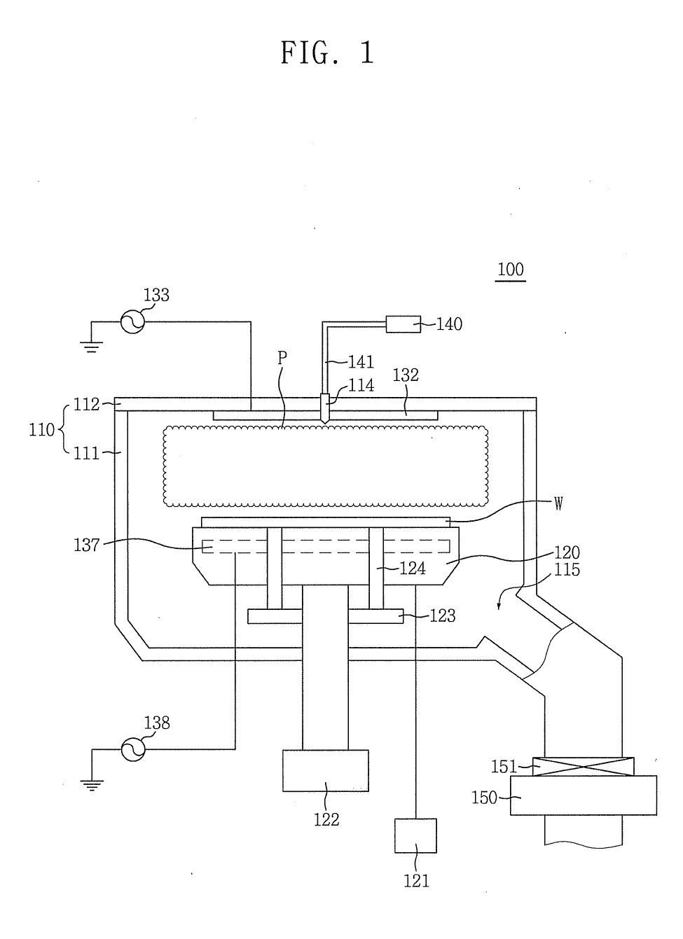

FIG. 1 is a cross-sectional view of a semiconductor manufacturing apparatus in accordance with a first example embodiment of the inventive concepts.

Referring to FIG. 1, a semiconductor manufacturing apparatus 100 in accordance with the first example embodiment of the inventive concepts includes a process chamber 110, a reaction gas supply portion 140, and an exhaust pump 150. Here, the reaction gas supply portion 140 is connected with a reaction gas injection portion 114 of the process chamber 110 via a supply pipe 141. Also, the exhaust pump 150 is connected with an exhaust terminal 115 of the process chamber 110.

Also, the semiconductor manufacturing apparatus 100 in accordance with the first example embodiment of the inventive concepts may further include an exhaust quantity controller 151 disposed between the exhaust terminal 115 and the exhaust pump 150. Here, the exhaust quantity controller 151 may be configured to sustain the internal pressure of the process chamber 110 within a constant pressure range.

The process chamber 110 is provided with a space in which the plasma is used to perform a certain process. The process chamber 110 includes an electrostatic chuck (ESC) 120 for holding a wafer (not shown), and first and second electrodes 132 and 137 for generating plasma. Here, the first electrode 132 may be disposed to face the ESC 120. Also, the second electrode 137 may be disposed in or on the ESC 120.

Although FIG. 1 illustrates the first electrode 132 as being in the process chamber 110, the inventive concepts are not limited thereto. For example, in some other example embodiments, the first electrode 132 may be disposed outside the process chamber 110, but a description of that arrangement will be omitted for brevity.

The process chamber 110 may be composed of a process chamber wall 111 and a lid 112 coupled with the process chamber wall 111. In this example embodiment, the first electrode 132 may be disposed in or on the lid 112. In addition, the process chamber 110 may further include the reaction gas injection portion 114. In this example embodiment, the reaction gas injection portion 114 may extend through the lid 112 and below the first electrode 132, however, example embodiments are not limited thereto as the reaction gas injection portion 114 may terminate at a point above the first electrode 132.

In this example embodiment, the ESC 120 may be configured to hold a wafer (not shown) during a certain process. The ESC 120 may cool the wafer which may be in contact with hot plasma. In some example embodiments, the ESC 120 may be in contact with a cooling unit 122 for this purpose. The cooling unit 122 may function to supply a coolant gas or a cooling solution to a circulation pipe (not shown) which may be formed in the ESC 120. For example, the coolant gas may be helium gas.

The ESC 120 may prevent the wafer from being spaced apart from the ESC 120 by means of the helium gas. In this case, the ESC 120 uses an electrostatic force to clamp the wafer. For this purpose, the ESC 120 is connected to a high-voltage supply portion 121 to generate the electrostatic force.

That is, when the wafer is put on the ESC and the voltage generation portion applies a voltage to the wafer, the potential difference between the wafer and the ESC occurs by means of the high direct-current voltage. Then, the dielectric polarization in an insulator of the ESC is caused by the potential difference. For example, a region close to a positive electrode is electrified with negative charges, and a region far from the positive electrode is electrified with positive charges. The electrostatic force is generated by such charge electrification, thereby enabling the ESC to clamp the wafer. In this example embodiment, the voltage may or may not be predetermined.

In this example embodiment, the high-voltage supply portion 121 may apply a voltage of approximately 400 V in order to stably hold the wafer. When the certain process is completed, the electrostatic force may be removed from the ESC 120 to de-chuck the wafer. For this purpose, the high-voltage supply portion 121 may cut off the voltage which is supplied to the ESC 120 after the certain process.

The first and second electrodes 132 and 137 may be configured to supply a constant voltage so as to generate plasma. For this purpose, the first and second electrodes 132 and 137 may be connected to a first voltage source 133 and a second voltage source 138, respectively. Example embodiments, however, are not limited thereto. For example, one of the first and second electrodes 132 and 137 may be connected to a ground or a reference voltage source rather than one of the first and second voltage sources 133 and 138. The voltage supplied from the first and second voltage sources 133 and 138 may be a radio frequency voltage.

Meanwhile, the process chamber 110 may further include an edge ring (not shown). The edge ring is a confinement assembly for defining a plasma generation region P in which plasma is generated, but its detailed description will be omitted for clarity.

In addition, the semiconductor manufacturing apparatus 100 in accordance with the first example embodiment of the inventive concepts may further include a lift 123 to hold and de-chuck the wafer (not shown) in a more stable manner. The lift 123 may support a bottom surface of the wafer using lift pins 124 passing through the ESC 120.

Next, the cleaning method of the semiconductor manufacturing apparatus in accordance with the first example embodiment of the inventive concepts will be described in detail, as follows.

In an example operation, the semiconductor manufacturing apparatus in accordance with the first example embodiment adheres a wafer (not shown) to the ESC 120 in the process chamber 110 and feeds a process gas into the process chamber 110 while sustaining its pressure and temperature to levels suitable for the process conditions. Then, a constant voltage is applied between the first electrode 132 and the second electrode 137 to generate plasma P.

Subsequently, the generated plasma P is used to perform a certain process. In this case, the certain process may be a dry etching process using plasma. However, in the inventive concepts, the kind of the certain process is not limited thereto.

In the case of dry etching, a large amount of reaction by-products is formed in the dry etching process using plasma, as described above. These by-products are discharged from the process chamber 110 via an exhaust pipe, but some of them are stuck to structures which are disposed in the process chamber 110, for example, the ESC 120, the process chamber wall 111, etc. The characteristics of various etching processes are changed by the sticking of such a reaction by-product as the number of the wafers (not shown) to be processed is increased. As a representative phenomena, reactive radicals, which are out-gassed from the deposited reaction by-products during the process, change an etching rate or alter an etch selectivity of a material to be etched to a material not to be etched, and unstably deposited reaction by-products are dropped on the wafer (not shown) during the process, which leads to unusual pattern shapes. Therefore, these reaction by-products should be removed by an in-situ dry cleaning (ISD) process, which is one of the cleaning methods of the semiconductor device using plasma.

When the etching process of the wafer stuck to the ESC 120 is completed, the conventional ISD process is carried out by supplying a direct-current voltage (Vdc) of 0 V to the ESC 120 to de-chuck the wafer from the ESC 120 and unload the de-chucked wafer from the process chamber 110. Then, a constant radio frequency voltage is applied between the first electrode 132 and the second electrode 137, thereby generating the plasma P and enabling electrons and ions generated in the plasma to start moving by means of the electric field and sheath.

Meanwhile, when a dummy wafer W is loaded into the process chamber 110, the dummy wafer W may be disposed on the ESC from which the wafer is de-chucked, as shown in FIG. 1. A relatively smaller amount of reaction by-products is present in the surface of the ESC since the wafer (not shown) is held during the dry etching process using the plasma, and thus the surface of the ESC in which the small amount of reaction by-products is present may be protected by the dummy wafer W during the ISD process.

However, although the dummy wafer W is shown in FIG. 1 for convenience of description, the inventive concepts is characterized in that the dummy wafer W is not necessarily present during the cleaning process, as described later.

That is, since a relatively small amount of reaction by-products is present in the surface of the ESC as compared to other regions of the process chamber, for example, an upper portion of the process chamber having the first electrode disposed therein, the process chamber wall, etc., cleaning the surface of the ESC is carried out at a lower cleaning frequency than cleaning the other regions.

However, the accommodation of the additional dummy wafer to protect the surface of the ESC during the cleaning process corresponds to the addition of a process. Also, when the additional dummy wafer is not held, the plasma is unnecessarily in contact with the surface of the ESC, which leads to damage to the ESC.

Of course, this does not mean that there is no need to clean the ESC, but means that, although there is a lower need to clean the ESC as compared to the other regions of the process chamber, the contact of the ESC with the plasma at the same cleaning frequency as the other regions results in damage to the ESC. As a result, it is problematic for the ESC to come into indiscriminate contact with the plasma.

Therefore, in order to prevent the ESC from being in indiscriminate contact with the plasma and exclude the process of placing an additional dummy wafer on the surface of the ESC, the inventive concepts are characterized in that the high-voltage supply portion 121 applies a direct-current voltage to the ESC during the cleaning process.

More specifically, the cleaning method of the semiconductor manufacturing apparatus in accordance with the first example embodiment of the inventive concepts includes supplying a cleaning gas into the process chamber including an ESC.

That is, the cleaning gas is supplied from the reaction gas supply portion 140. In this case, since the reaction gas supply portion 140 is connected to the reaction gas injection portion 114 of the process chamber 110 via the supply pipe 141, the cleaning gas is supplied into the process chamber through the reaction gas injection portion 114 of the process chamber 110.

The cleaning gas may be one selected from the group consisting of BClₓ, SiClₓ, SF₆, NF₃, Cl₂, SiBr₄, C₄F₆, C₄F₈, CF₅, and CHF₃, but the kind of the cleaning gas of the inventive concepts is not limited thereto.

Next, plasma is generated from the cleaning gas. That is, a constant voltage is applied between the first electrode 132 and the second electrode 137, thereby generating the plasma P. Here, a radio frequency voltage may be applied to the first electrode 132 and the second electrode 137. In the alternative, one of the first and second electrodes 132 and 137 may be connected to a ground or a reference voltage source. In this case, a voltage for generating the plasma is applied to the other electrode.

Then, the plasma P is used to clean the process chamber of the semiconductor manufacturing apparatus.

In this case, the cleaning method for cleaning the semiconductor manufacturing apparatus in accordance with the first example embodiment of the inventive concepts is characterized in that the high-voltage supply portion 121 applies a direct-current voltage to the ESC during the cleaning of the process chamber, as described above.

That is to say, the cleaning method of the semiconductor manufacturing apparatus in accordance with the first example embodiment of the inventive concepts includes selectively applying a positive direct-current voltage and/or negative direct-current voltage to the ESC for selective contact with the plasma.

More particularly, when the high-voltage supply portion 121 applies the positive direct-current voltage to the ESC, the ESC is protected, and the cleaning effect by the plasma of the inner portion of the process chamber except for the ESC, for example, the process chamber wall, may be maximized. Also, when the high-voltage supply portion 121 applies the negative direct-current voltage to the ESC, the ESC is cleaned by the plasma.

That is, it is possible to protect or clean the ESC, depending on the condition of whether the positive or negative direct-current voltage is applied to the ESC in the inventive concepts, which indicates that the ESC may be in selective contact with the plasma.

Hereinafter, a mechanism of protecting or cleaning the ESC according to the kind of the voltages applied to the ESC will be described, as follows.

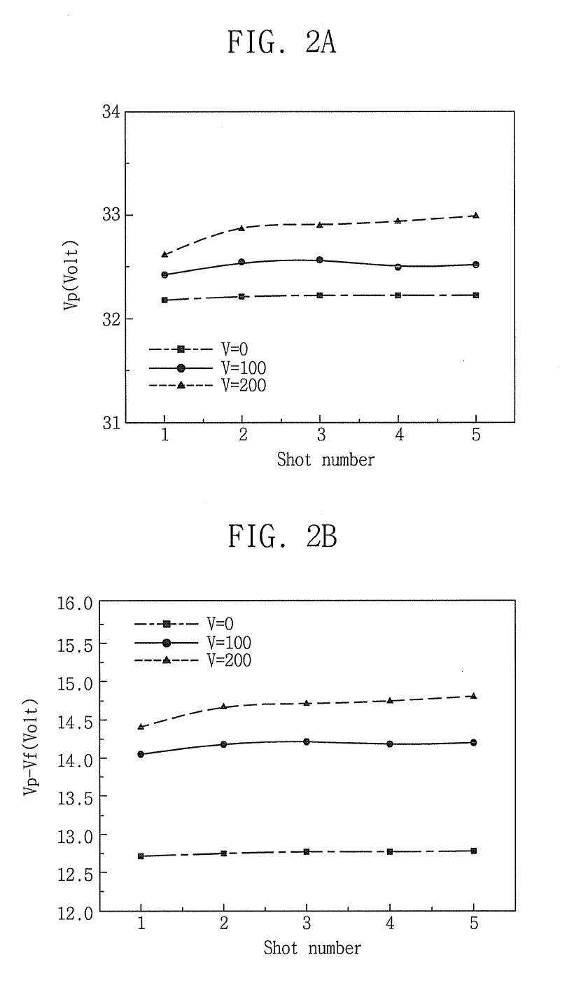

FIG. 2A is a graph illustrating changes in potential (Vp) of plasma, depending on the application of voltage to an ESC, and FIG. 2B is a graph illustrating the potential difference between the potential (Vp) of the plasma and the potential (Vf) of a process chamber wall, depending on the application of voltage to the ESC. Here, the process conditions in FIGS. 2A and 2B are as follows: a pressure of 50 mT, a power of 500 W and a gas flow rate of 300 sccm.

Referring to FIG. 2A, it is seen that the more the voltage applied to the ESC increases, the more the potential (Vp) of the plasma increases, which indicates that the sheath on the surface of the ESC is decreased in thickness.

Referring to FIG. 2B, it is seen that the more the voltage applied to the ESC increases, the more the potential difference (Vp−Vf) between the potential (Vp) of the plasma and the potential (Vf) of the process chamber wall increases, which indicates that the increase in potential difference between the plasma and the process chamber wall causes an increase in energy of plasma ions which reach the process chamber wall.

This mechanism may be applied to the inventive concepts, as follows.

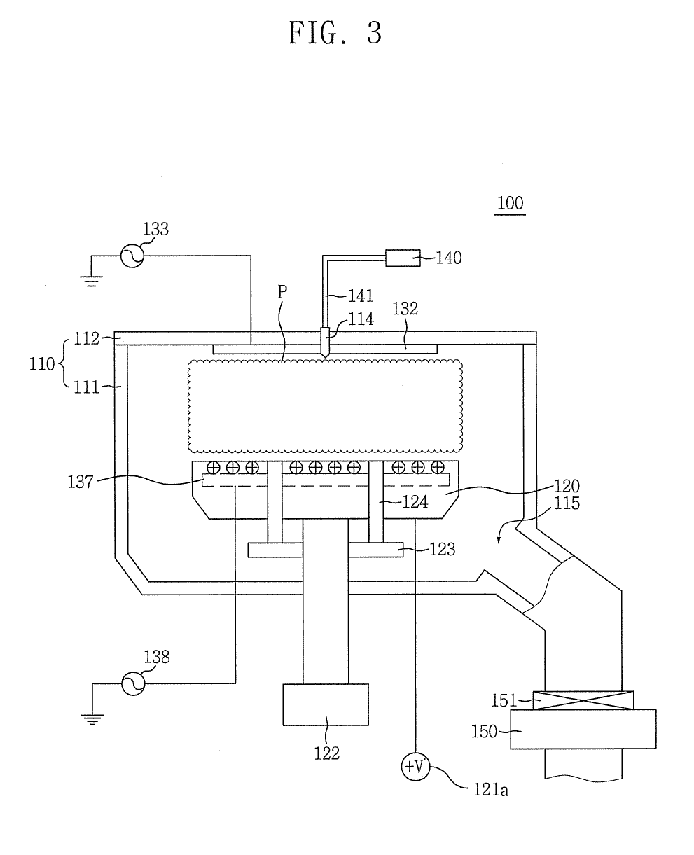

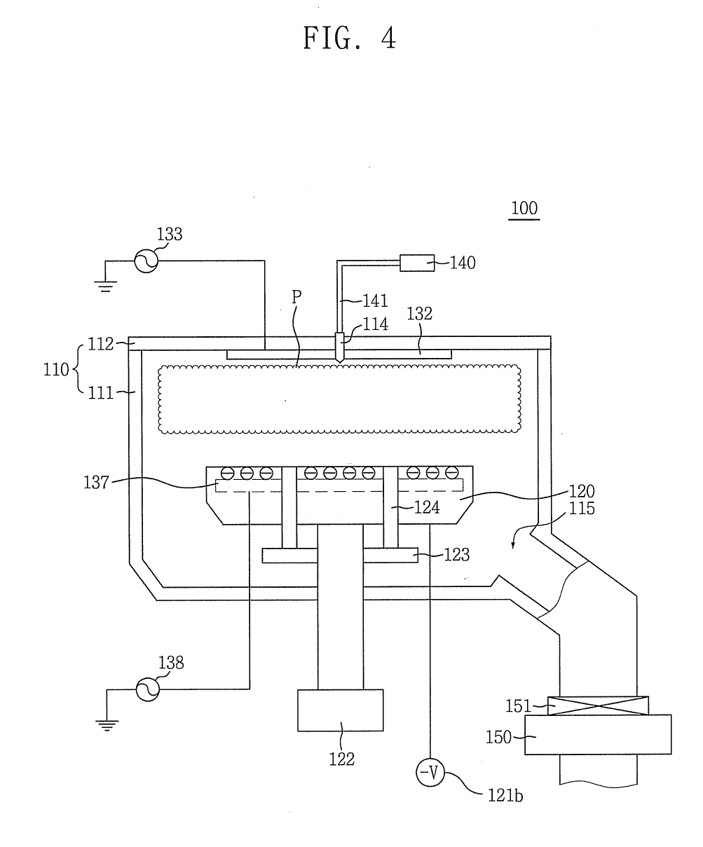

FIG. 3 is a diagram showing the state of plasma when a positive direct-current voltage is applied to an ESC, and FIG. 4 is a diagram showing the state of plasma when a negative direct-current voltage is applied to the ESC. The semiconductor manufacturing apparatus 100 as shown in FIGS. 3 and 4 has the same configuration as that of FIG. 1, except for the parts described later. Also, it is assumed that the plasma P shown in FIG. 1 is plasma when a direct-current voltage is not applied to the ESC, for convenience of description.

Referring to FIG. 3, when the high-voltage supply portion applies a positive direct-current voltage 121a to the ESC as described above, the potential (Vp) of the plasma increases, compared to that of FIG. 1. Also, the sheath on the surface of the ESC is decreased in thickness more than when the direct-current voltage is not applied to the ESC.

In this case, when a constant radio frequency voltage is applied between the first electrode 132 and the second electrode 137 to generate plasma during the cleaning process using plasma, electrons and ions generated in the plasma start to move by means of the electric field and sheath. In this case, the electrons have excellent mobility since their mass is relatively small compared to the ions. As a result, the electrons accumulate on the surfaces of all the structures in the process chamber, which allows the surface of all the structures to carry a negative potential and the plasma to carry a positive potential.

Therefore, since the inner portion of the ESC is electrified with positive charges when the positive direct-current voltage is applied to the ESC, the sheath is decreased in thickness, and the cation acceleration in the sheath is slowed down.

That is, the cleaning method of the semiconductor manufacturing apparatus in accordance with the first example embodiment of the inventive concepts may be useful in slowing down the cation acceleration in the sheath through the decrease in thickness of the sheath on the surface of the ESC by applying the positive direct-current voltage to the ESC, and in protecting the ESC as well by electrifying the inner portion of the ESC with positive charges to prevent high-energy cations from reaching the surface of the ESC.

Also, the cleaning method of the semiconductor manufacturing apparatus in accordance with the first example embodiment of the inventive concepts may be useful in protecting the surface of the ESC without holding an additional dummy wafer, which is configured to protect the surface of the ESC in the ISD process.

Meanwhile, when the high-voltage supply portion applies a positive direct-current voltage 121a to the ESC, the potential difference (Vp−Vf) between the potential (Vp) of the plasma and the potential (Vf) of the process chamber wall is increased, compared to that of FIG. 1. As a result, the increase in potential difference between the plasma and the process chamber wall causes an increase in energy of plasma ions which reach the process chamber wall, which leads to the maximum cleaning effect by means of the plasma in the process chamber except for the ESC, more specifically the plasma stuck to the process chamber wall.

Also referring to FIG. 4, as the high-voltage supply portion applies a negative direct-current voltage 121b to the ESC, unlike in FIG. 3, the potential (Vp) of the plasma is decreased, compared to that of FIG. 1, and the sheath on the surface of the ESC is increased in thickness more than when the direct-current voltage is not supplied to the ESC.

Therefore, as the sheath carrying a negative potential is increased in thickness, the cation acceleration in the sheath is sped up. Since the inner portion of the ESC is electrified with negative charges when the negative direct-current voltage is applied to the ESC, a larger quantity of high-energy cations may also reach the surface of the ESC.

That is, the cleaning method of the semiconductor manufacturing apparatus in accordance with the first embodiment of the inventive concepts may be useful in speeding up the cation acceleration in the sheath through the increase in thickness of the sheath on the surface of the ESC by applying the negative direct-current voltage to the ESC, and in selectively cleaning the ESC by electrifying the inner portion of the ESC with negative charges so as to enhance the effect of the high-energy cations reaching the surface of the ESC.

Meanwhile, when the high-voltage supply portion applies a negative direct-current voltage 121b to the ESC, the potential difference (Vp−Vf) between the potential (Vp) of the plasma and the potential (Vf) of the process chamber wall is decreased, compared to that of FIG. 1. As a result, the decrease in potential difference between the plasma and the process chamber wall causes a decrease in energy of plasma ions which reach the process chamber wall, which leads to a decrease in cleaning effect by means of the plasma in the process chamber except for the ESC, more specifically the plasma stuck to the process chamber wall.

As described above, the inventive concepts have no problems despite the deterioration of the cleaning effect due to the plasma of the process chamber wall when the negative direct-current voltage is applied to the ESC. This is why it is possible for the ESC to be in selective contact with the plasma, depending on the condition of whether the positive or negative direct-current voltage is applied to the ESC in the inventive concepts.

### Second Example Embodiment

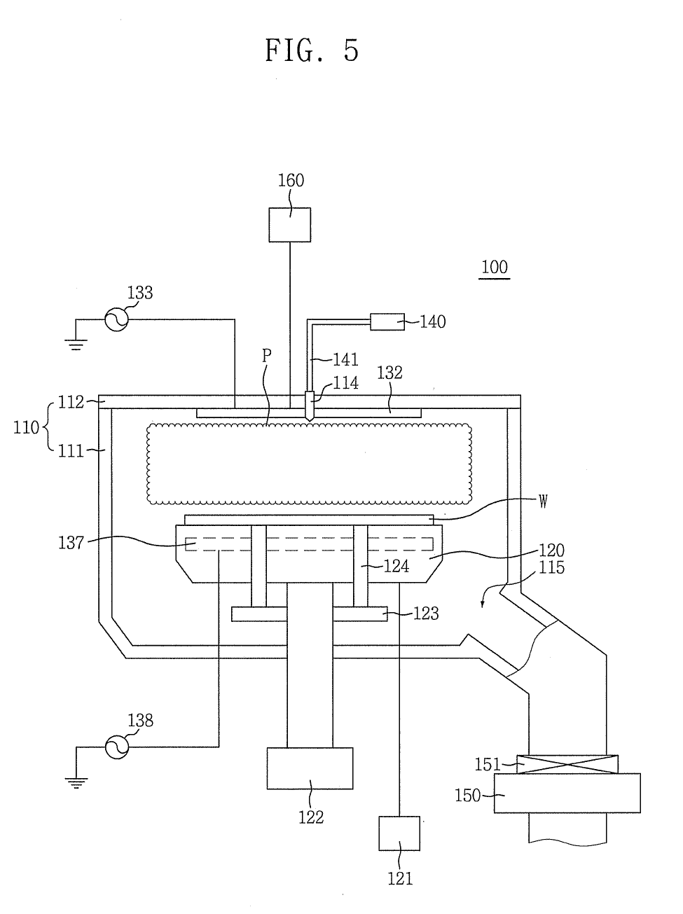

FIG. 5 is a cross-sectional view of a semiconductor manufacturing apparatus in accordance with a second example embodiment of the inventive concepts. The semiconductor manufacturing apparatus in accordance with the second example embodiment of the inventive concepts has the same parts as the first example embodiment of the inventive concepts, except for the parts described herein.

Referring to FIG. 5, the semiconductor manufacturing apparatus in accordance with the second example embodiment of the inventive concepts may include a high-voltage supply portion 160 which is disposed in the first electrode 132, separately from the first voltage source 133, for supplying a constant voltage to generate plasma. In this case, the high-voltage supply portion 160 may be connected in parallel to the first voltage source 133.

The high-voltage supply portion 160 may be connected to the first electrode 132 in order to enable the high-voltage supply portion 160 to perform the same operations as the high-voltage supply portion formed in the ESC.

That is, the potential (Vp) of the plasma increases as a positive direct-current voltage is applied to the high-voltage supply portion 160, and a sheath on the surface of the ESC is decreased in thickness more than when the direct-current voltage is not supplied to the ESC.

Also, the potential (Vp) of the plasma decreases as a negative direct-current voltage is applied to the high-voltage supply portion 160, and the sheath on the surface of the ESC is increased in thickness more than when the direct-current voltage is not supplied to the ESC.

Therefore, the cleaning method of the semiconductor manufacturing apparatus in accordance with the second example embodiment of the inventive concepts may be useful in enhancing the effects according to the inventive concepts by applying a direct-current voltage similar to the direct-current voltage applied to the ESC to the first electrode. In this example embodiment, the high voltage supply portion 160 and the high voltage supply portion 121 may have the same source. Thus, they may apply identical voltages to the first electrode 132 and the second electrode 137, however, example embodiments are not limited thereto as the high voltage supply portion 160 and the high voltage supply portion 121 may have a different voltage source.

### Third Example Embodiment

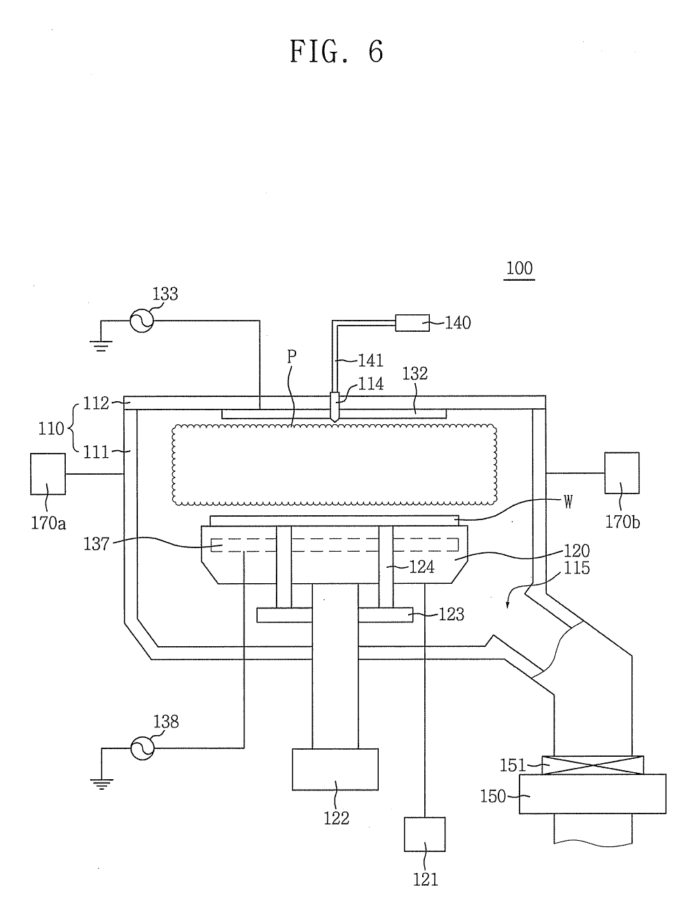

FIG. 6 is a cross-sectional view of a semiconductor manufacturing apparatus in accordance with a third example embodiment of the inventive concepts. The semiconductor manufacturing apparatus in accordance with the third example embodiment of the inventive concepts has the same parts as the first example embodiment of the inventive concepts, except for the parts described herein.

Referring to FIG. 6, the semiconductor manufacturing apparatus in accordance with the third example embodiment of the inventive concepts may include additional high-voltage supply portions 170a and 170b formed in the process chamber wall 111.

In this case, the high-voltage supply portions 170a and 170b may be formed in the process chamber wall 111 to perform the same operations as the high-voltage supply portion formed on the ESC. However, the high-voltage supply portion formed on the process chamber wall is configured to apply an opposite direct-current voltage to that of the ESC.

That is, as a positive direct-current voltage is applied to the high-voltage supply portions 170a and 170b, the potential difference (Vp−Vf) between the potential (Vp) of the plasma and the potential (Vf) of the process chamber wall is decreased, compared to that of FIG. 1. As a result, the decrease in the potential difference between the plasma and the process chamber wall causes the decrease in energy of plasma ions which reach the process chamber wall, which leads to a decrease in cleaning effect by means of the plasma in the process chamber except for the ESC, more specifically the plasma stuck to the process chamber wall.

Also, as a negative direct-current voltage is applied to the high-voltage supply portions 170a and 170b, the potential difference (Vp−Vf) between the potential (Vp) of the plasma and the potential (Vf) of the process chamber wall is increased, compared to that of FIG. 1. As a result, the increase in potential difference between the plasma and the process chamber wall causes an increase in energy of plasma ions which reach the process chamber wall, which leads to the maximum cleaning effect by means of the plasma in the process chamber except for the ESC, more specifically the plasma stuck to the process chamber wall.

Therefore, the cleaning method of a semiconductor manufacturing apparatus in accordance with the third example embodiment of the inventive concepts may be useful in enhancing the effects according to the inventive concepts by applying the opposite direct-current voltage to the direct-current voltage applied to the ESC to the process chamber wall 111.

As described above, example embodiments of the inventive concepts can provide cleaning and plasma processing methods of a semiconductor manufacturing apparatus capable of preventing or reducing damage to an ESC by selectively adjusting a quantity of plasma which is fed to the surface of the ESC.

Also, the example embodiments of the inventive concepts can be useful in minimizing the damage to the ESC caused by plasma and maximizing the cleaning efficiency.

The foregoing is illustrative of the example embodiments and is not to be construed as limiting thereof. Although a few example embodiments have been described, those skilled in the art will readily appreciate that many modifications are possible in the example embodiments without materially departing from the novel teachings and advantages. Accordingly, all such modifications are intended to be included within the scope of the inventive concepts as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific example embodiments disclosed, and that modifications to the disclosed embodiments, as well as other embodiments, are intended to be included within the scope of the appended claims.

1. A method of cleaning a semiconductor manufacturing apparatus having a process chamber and an electrostatic chuck (ESC), the method comprising:
supplying a cleaning gas into the process chamber;
generating plasma from the cleaning gas; and
applying a direct-current voltage to the ESC during a cleaning of at least one of the process chamber and the ESC.

2. The cleaning method according to claim 1, wherein applying a direct-current voltage to the ESC includes applying a negative direct-current voltage to the ESC to clean the ESC.

3. The cleaning method according to claim 1, wherein applying a direct-current voltage to the ESC includes applying a positive direct-current voltage to the ESC to reduce a sheath on a surface of the ESC.

4. The method according to claim 1, wherein applying a direct-current voltage to the ESC includes applying a negative direct-current voltage to the ESC to increase a sheath on a surface of the ESC.

5. The method according to claim 4, wherein applying a direct-current voltage to the ESC includes applying a negative direct-current voltage to the ESC to increase a sheath on a surface of the ESC and applying a positive direct-current voltage to the ESC to decrease the sheath on the surface of the ESC.

6. The method according to claim 1, wherein
when the applied direct-current voltage is positive, a potential (Vp) of the plasma increases, and
when the applied direct-current is negative, the potential (Vp) of the plasma decreases.

7. The method according to claim 1, wherein the applying a direct-current voltage to the ESC includes applying a positive direct-current and a negative direct-current and a potential (Vp) of the plasma on application of the positive direct-current voltage is greater than a potential (Vp) of the plasma on application of the negative direct-current voltage.

8. The method according to claim 1, wherein the applying a direct-current voltage to the ESC includes applying a positive direct-current and a negative direct-current, and a potential difference between a potential (Vp) of the plasma and a potential (Vf) of the process chamber wall increases by the application of the positive direct-current voltage, and decreases by the application of the negative direct-current voltage.

9. The method according to claim 1, wherein applying a direct-current voltage to the ESC includes applying a positive direct-current and a negative direct-current, and a potential difference between the potential (Vp) of the plasma and a potential (Vf) of the chamber wall on application of the positive direct-current voltage is greater than the potential difference between the potential (Vp) of the plasma and the potential (Vf) of the chamber wall on application of the negative direct-current voltage.

10. The method according to claim 1, wherein a wafer or a dummy wafer is not disposed on the ESC during the applying a direct-current voltage to the ESC during a cleaning.

11. The method according to claim 1, further comprising:
applying a direct-current voltage to a first electrode of the apparatus while applying the direct-current voltage to the ESC.

12. The method according to claim 1, further comprising:
applying an opposite direct-current voltage to the process chamber while applying the direct-current voltage to the ESC.

13. A method of plasma processing an apparatus for manufacturing a semiconductor, comprising:
applying a positive direct-current voltage to an electrostatic chuck (ESC) and applying a negative direct-current voltage to the ESC while cleaning the semiconductor manufacturing apparatus with plasma,
wherein a wall of the process chamber is cleaned by applying the positive direct-current voltage to the ESC.

14. The method according to claim 13, wherein the cleaning comprises:
supplying a cleaning gas into the process chamber;
generating plasma from the cleaning gas; and
cleaning the semiconductor manufacturing apparatus with the plasma.

15. The method according to claim 13, wherein the ESC is cleaned by applying the negative direct-current voltage to the ESC.

16. A method of cleaning an apparatus for manufacturing a semiconductor comprising:
applying a direct current voltage to a first element of the apparatus to adjust a sheath on the first element to one of protect the first element from plasma and clean the first element using the plasma.

17. The method according to claim 16, wherein first element is an electrostatic chuck (ESC).

18. The method according to claim 17, wherein the direct current voltage is positive to protect the ESC and negative to clean the ESC.

19. The method according to claim 18, wherein the direct current voltage is simultaneously applied to an electrode in the apparatus, the electrode being arranged such that the plasma is between the electrode and the ESC.

20. The method according to claim 18, further comprising:
applying a second direct current voltage while applying the direct current voltage to the ESC, the second direct voltage being applied to a process chamber wall of the apparatus and being opposite to the direct current voltage applied to the ESC.
